(19) United States
(12) Patent Application Publication
(10) Pub. No.: US 2024/0215014 A1
(43) Pub. Date: Jun. 27, 2024

(54) FR2 UL GAP CONFIGURATION

(71) Applicant: Apple Inc., Cupertino, CA (US)

(72) Inventors: Huaning Niu, San Jose, CA (US); Dawei Zhang, Saratoga, CA (US); Haijing Hu, Los Gatos, CA (US); Jie Cui, San Jose, CA (US); Qiming Li, Beijing (CN); Sharad Sambhwani, San Diego, CA (US); Xiang Chen, Campbell, CA (US); Yang Tang, San Jose, CA (US); Yuqin Chen, Beijing (CN)

(21) Appl. No.: 17/918,338

(22) PCT Filed: Oct. 21, 2021
(86) PCT No.: PCT/CN2021/125352

§ 371 Date: Oct. 12, 2022

(51) Int. Cl. H04W 72/1268; H04W 52/34

(52) U.S. Cl. CPC H04W 72/1268; H04W 52/34

(57) ABSTRACT

Apparatuses for FR2 UL gap configuration, and associated configuring methods. In one aspect, a dedicated radio resource control (RRC) signaling is used to configure a UL gap by transmitting. The UL gap configuration may indicate a reference cell to determine a UL gap pattern for a multi-radio dual connectivity (MR-DC) configuration. The UL gap configuration may indicate a system frame number (SFN) and a subframe of the reference cell used for calculating the UL gap pattern. The reference cell can be selected from a list of cells including FR1 cells or can be limited to FR2 cells.

### FIELD

This invention relates to wireless data transmission technology and to transmission configuration for high frequency band.

### BACKGROUND

Wireless communication networks may include user equipment (UEs) (e.g., smartphones, tablet computers, etc.) capable of communicating with base stations and other network nodes. Aspects of wireless communication networks include the manner, conditions, scenarios, and procedures by which wireless devices connect and otherwise communicate with one another. This may involve issues relating to how wireless devices may synchronize and reserve transmission slots for various measurements.

### BRIEF DESCRIPTION OF THE DRAWINGS

FIG. 1 illustrates a block diagram illustrating an architecture of a wireless system including a user equipment (UE) communicating with a base station (BS) with an uplink (UL) gap pattern in accordance with some aspects.

FIG. 2 illustrates an example of a slot configuration including a UL gap pattern in accordance with some aspects.

FIG. 3 illustrates another example of a slot configuration including a UL gap pattern in accordance with some aspects.

FIG. 4 illustrates a plurality of table diagrams illustrating a list of UL gap pattern parameters.

FIG. 5 illustrates a diagram illustrating an example definition of UL gap configuration of an RRC message in accordance with some aspects.

FIG. 6 illustrates a flow diagram illustrating a method of configuring UL gap for a UE using an RRC message in accordance with some aspects.

FIG. 7 illustrates a table diagram illustrating master node (MN)-secondary node (SN) coordination for gap configuration in accordance with some aspects.

FIG. 8 illustrates a diagram illustrating example components of a device that can be employed in accordance with some aspects.

FIG. 9 illustrates a diagram illustrating example interfaces of baseband circuitry that can be employed in accordance with some aspects.

### DETAILED DESCRIPTION

The present disclosure is described with reference to the attached figures. The like reference numerals are used to refer to like elements throughout. The figures are not drawn to scale, and they are provided merely to illustrate the disclosure. Several aspects of the disclosure are described below with reference to example applications for illustration. Numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the selected present disclosure.

The enhancement of Frequency Range 2 (FR2) coverage is of interest including improving signal quality, power efficiency and overall system throughput in wireless communications systems. Various FR2 enhancements rely on or benefit from the use of an uplink (UL) gap. The UL gap may represent one or more UL slots during which UL data transmission is paused for performing additional measurement using the hardware for UL data transmission. For example, as explained in more details below, a FR2 transmission power management can be performed using the UL gap, since it uses FR2 transceiver for body proximity sensing and thus cannot be concurrently performed with the UL data transmission.

In view of the above, the disclosure is related to apparatuses for FR2 UL gap configuration, and associated configuring methods. In one aspect, a dedicated radio resource control (RRC) signaling is used to configure a UL gap by transmitting. The UL gap configuration may indicate a reference cell to determine a UL gap pattern for a multi-radio dual connectivity (MR-DC) configuration. The UL gap configuration may indicate a system frame number (SFN) and a subframe of the reference cell used for calculating the UL gap pattern. The reference cell can be selected from a list of cells including FR1 cells or can be limited to FR2 cells.

In one aspect, the UL gap configuration further indicates a UL gap length (UGL), a UL gap repetition period (UGRP), and a UL gap offset to determine the UL gap pattern. The UGL and the UGRP may be represented by a UL gap pattern ID. Alternatively, the UGL and the UGRP may be represented by bits representing the UGL and the UGRP respectively. In some further alternative aspects, a UL gap length, a UL gap repetition period, and a UL gap offset of the UL gap are provided by a different source, for example, by a dynamic scheduling using downlink control information (DCI) or by a common or dedicated time division duplex (TDD) uplink/downlink configuration.

In one aspect, the UL gap configuration also indicates the support of a per-FR gap, where FR1 data transmission still continues during the UL gap. In one aspect, the UL gap is independent from a measurement gap, such that user equipment (UE) measurements continue through an internal loop when the indicating measurement gap overlaps with the UL gap.

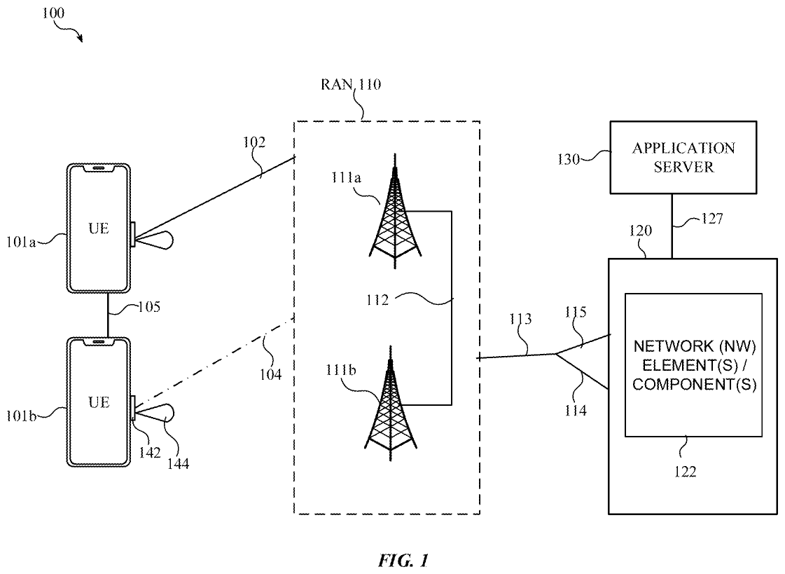

FIG. 1 illustrates a block diagram illustrating an architecture of a wireless system 100 including a UE 101 communicating with a base station (BS) 11 with an uplink (UL) gap pattern in accordance with some aspects. The following description is provided in conjunction with 5G or NR system standards as provided by 3GPP technical specifications. However, the example aspects are not limited in this regard, and the described aspects can apply to other networks that benefit from the principles described herein, such as other 3GPP systems (e.g., Fourth Generation (4G) or Sixth Generation (6G)) systems, IEEE 802.16 protocols (e.g., WMAN, WiMAX, etc.), or the like.

As shown by FIG. 1, the wireless system 100 includes UE 101a and UE 101b (collectively referred to as “UEs 101” or “UE 101”). The UEs 101 can be configured to connect, for example, communicatively couple, with a Radio Access Network (RAN) 110 utilizing connections (or channels) 102 and 104, which respectively comprise a physical communications channel/interface. The RAN 110 can include one or more RAN nodes, including base stations (BS) 111a and 111b (collectively referred to as “BS 111”), that enable the connections 102 and 104.

In some aspects, the UE 101 may perform a FR2 transmission power management using a FR2 UL gap during which regular uplink data transmission is paused. For example, the UE 101 may selectively apply additional power management maximum power reduction (P-MPR) or operating duty cycle in compliance of a 5G FR2 cellular radio regulatory only when human targets are at positions in which significant RF exposure by a directional beam 144 can be caused, and thus improve overall system throughput. A body proximity sensor can be utilized to detect presence or absence of human target(s) in close proximity around a radiating FR2 antenna panel 142. Since the body proximity sensor may not be able to concurrently operate with a 5G NR FR2 transceiver, the FR2 UL gap needs to be created and configured to allow for the body proximity detection. As will be described in more details below, sensing gaps/slots are configured between the regular DL and UL slots to determine a UL gap pattern.

The UEs 101 are illustrated as smartphones (e.g., handheld touchscreen mobile computing devices connectable to one or more cellular networks), but can comprise any mobile or non-mobile computing device, such as consumer electronics devices including headset, handset, cellular phones, smartphones, feature phones, tablet computers, wearable computer devices, personal digital assistants (PDAs), pagers, wireless handsets, desktop computers, laptop computers, in-vehicle infotainment (WI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, Machine Type Communication (MTC) devices, Machine to Machine (M2M), Internet of Things (IoT) devices, and/or the like.

In some aspects, the RAN 110 can be a next generation (NG) RAN or a 5G RAN, an evolved-UMTS Terrestrial RAN (E-UTRAN), or a legacy RAN, such as a UTRAN or GERAN. As used herein, the term “NO RAN” or the like can refer to a RAN 110 that operates in an NR or 5G wireless system, and the term “E-UTRAN” or the like can refer to a RAN 110 that operates in a long term evolution (LTE) or 4G system. In this example, the connections 102 and 104 are illustrated as an air interface to enable communicative coupling and can be consistent with cellular communications protocols, such as a Global System for Mobile communications (GSM) protocol, a Code-Division Multiple Access (CDMA) network protocol, a Push-to-Talk (PIT) protocol, a PTT over-cellular (POC) protocol, a Universal Mobile Telecommunications Service (UMTS) protocol, a 3GPP LTE protocol, a 5G protocol, an NR protocol, and/or any of the other communications protocols discussed herein. In aspects, the UEs 101 can directly exchange communication data via a ProSe interface 105. The ProSe interface 105 can alternatively be referred to as an SL interface 105 and can comprise one or more logical channels, including but not limited to a physical sidelink control channel (PSCCH), a physical sidelink shared channel (PSSCH), a physical sidelink discovery channel (PSDCH), and a physical sidelink broadcast channel (PSBCH).

The BS 111a, 111b may be configured to communicate with one another via an interface 112. In implementations where the system is a 5G or NR system, the interface 112 can be an Xn interface 112. The Xn interface is defined between two or more BS 111. In some implementations, the Xn interface can include an Xn user plane (Xn-U) interface and an Xn control plane (Xn-C) interface. The Xn-U can provide non-guaranteed delivery of user plane PDUs and support/provide data forwarding and flow control functionality. The Xn-C can provide management and error handling functionality, functionality to manage the Xn-C interface: mobility support for UE 101 in a connected mode (e.g., CM-CONNECTED) including functionality to manage the UE mobility for connected mode between one or more BS 111. As used herein, the terms “access node.” “access point,” or the like can describe equipment that provides the radio baseband functions for data and/or voice connectivity between a network and one or more users. These BS can be referred to as access nodes, gNBs, RAN nodes. eNBs, NodeBs, RSUs. Transmission Reception Points (TRxPs) or TRPs, and so forth, and can comprise ground stations (e.g., terrestrial access points) or satellite stations providing coverage within a geographic area (e.g., a cell). According to various aspects, the BS 111 can be implemented as one or more of a dedicated physical device such as a macrocell base station and/or a low power (LP) base station for providing femtocells, picocells, or other like cells having smaller coverage areas, smaller user capacity, or higher bandwidth compared to macrocells.

The RAN 110 is communicatively coupled to a core network (CN) 120. The CN 120 can comprise a plurality of network elements 122 configured to offer various data and telecommunications services to customers/subscribers (e.g., users of UEs 101) who are connected to the CN 120 via the RAN 110. In aspects, where the CN 120 is an EPC, the RAN 110 can be connected with the CN 120 via an S1 interface 113. In embodiments, the S1 interface 113 can be split into two parts, an S1 user plane (S1-U) interface 114, which carries traffic data between the BS 111 and the S-GW, and the S1-MME interface 115, which is a signaling interface between the BS 11l and MMEs.

An application server 130 can be an element offering applications that use IP bearer resources with the CN 120 via an Internet Protocol (IP) interface 127 (e.g., Universal Mobile Telecommunications System Packet Services (UMTS PS) domain. LTE PS data services, etc.). The application server 130 can also be configured to support one or more communication services (e.g., VoIP sessions, PTT sessions, group communication sessions, social networking services, etc.) for the UEs 101 via the CN 120. The application server 130 can signal the CN 120 to indicate a new service flow and select an appropriate QoS and charging parameters with the appropriate traffic flow template (TFT) and QoS class of identifier (QCI), which commences the QoS and charging as specified by the application server 130.

As the number of mobile devices within wireless networks and the demand for mobile data traffic continue to increase, changes are made to system requirements and architectures to increase communication capacity and speed. An aspect of such changes may include dual connectivity (DC), where a secondary node (SN) is utilized to provide additional resources to the UEs 101 while a master node (MN) provides control plane connection to the core network. The UEs 101 can be configured with DC as a multi-RAT or multi-Radio Dual Connectivity (MR-DC), where a multiple Rx/Tx capable UE may be configured to utilize resources provided by two different nodes that can be connected via non-ideal backhaul, one providing NR access and the other one providing either E-UTRA for LTE or NR access for 50, for example. The MN and SN can be connected via a network interface, and at least the MN is connected to the CN 120. At least one of the MN or the SN can be operated with shared spectrum channel access. All functions specified for the UEs 101 can be used for integrated access and backhaul mobile termination (IAB-MT). Similar to the UEs 101, the IAB-MT can access the network using either one network node or using two different nodes with EN-DC architectures. NR-DC architectures, or the like. NR-DC is a DC configuration used in the 5G NR network, whereby both the MN and the SN are 5G gNBs. In EN-DC (Eutran NR Dual Connectivity), LTE would become an MCG (Master Cell Group), and NR would become an SCG (Secondary Cell Group).

In MR-DC, a group of serving cells associated with a master Node can be configured as a master cell group (MCG), comprising of a special cell (SpCell) as a primary cell (PCell) and optionally one or more secondary cells (SCells). An MCG can be the radio access node that provides the control plane connection to the core network (CN) 120; it may be a Master eNB (in EN-DC), a Master ng-eNB (in NGEN-DC), or a Master gNB (in NR-DC and NE-DC), for example. An SCG in MR-DC can be a group of serving cells associated with an SN, comprising the SpCell as a PSCell and optionally one or more SCells. Thus, SpCell can either refer to the PCell of the MCG or the primary secondary cell (PSCell) of a second cell group (SCG) depending on if the MAC entity is associated with the MCG or the SCG, respectively.

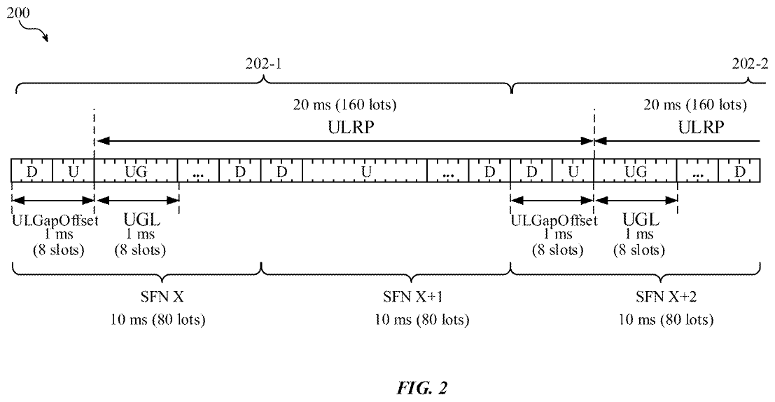

FIG. 2 illustrates an example of a slot configuration 200 including an uplink (UL) gap pattern 202 (202-1, 202-2) in accordance with some aspects. The UL gap pattern 202 includes parameters of a UL Gap Length (UGL), a UL Repetition Period (ULRP), and a UL gap offset (ULGapOffset). The ULGapOffset is an offset of the UL gap pattern 202 in reference to a start of the ULRP. The ULRP is a gap repetition period of the UL gap pattern 202. The UGL is a gap length of the UL gap pattern 202. The slot configuration 200 of FIG. 2 uses the example of a numerology with 80 slots in a radio frame and a subcarrier space (SCS) is 120 kHz, but other numerologies are also amenable by applying the same methodology.

As the example shown by FIG. 2, radio frames SFN X. SFN X+1, SFN X+2 respectively is 10 ms and 80 lots. In one aspect, the UL gap pattern 202 includes a plurality of clustered UL gap slots. The ULRP may be smaller, equal to, or greater than the length of a radio frame. Here, for example, the ULRP can be 20 ms and 160 lots crossing two radio frames. The ULRP may be an integer times of the period of the radio frame. A first slot of the UL gap immediately follows the ULGapOffset. The UL gap has a length of UGL including one or multiple slots in succession, 1 ms and 8 slots in the example.

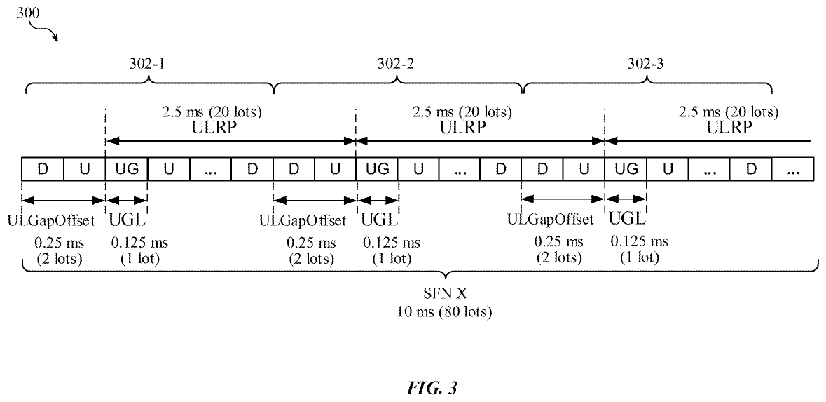

FIG. 3 illustrates another example of a slot configuration 300 including an uplink (UL) gap pattern 302 (302-1, 302-2, 302-3) in accordance with some aspects. Parameters of the UL gap pattern 302 are similar to what is described above regarding the UL gap pattern 202 of FIG. 2. In one aspect, the ULRP may be relative small, for example, smaller than the length of a radio frame, and the UL gap slots are distributed across different locations even within one radio frame. Thus, an impact of the UL gap to uplink data transmission can be reduced. The ULRP may be one of integer times of the period of the radio frame. As the example shown by FIG. 3, radio frames SFN X is 10 ms and 80 lots. The ULRP can be 2.5 ms and 20 lots, and 4 UL gap can be arranged within the radio frame SFN X. A first slot of the UL gap immediately follows the ULGapOffset. The UL gap has a length of UGL including one or multiple slots in succession, 0.125 ms and 1 slot in the example.

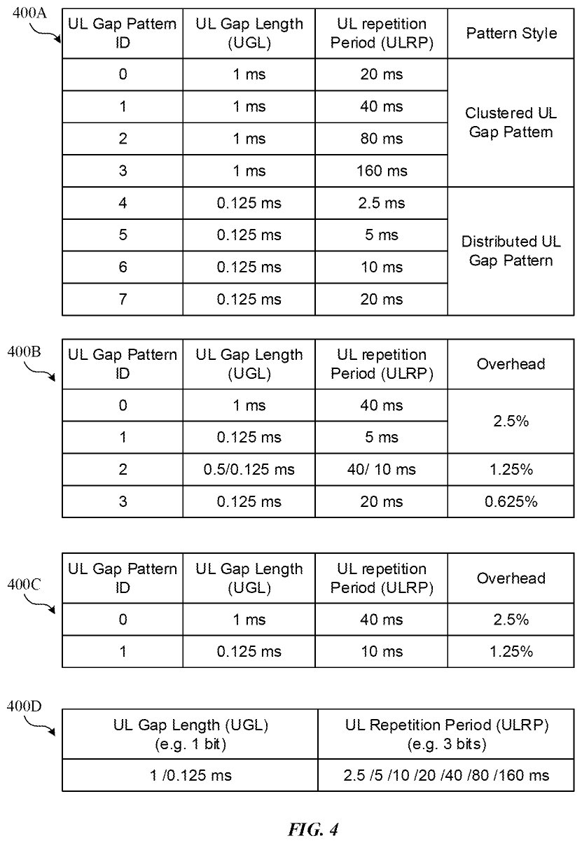

FIG. 4 illustrates a plurality of table diagrams 400A-400D illustrating a list of UL gap pattern parameters. As shown by the table diagrams 400A-400C, a plurality of UL gap pattern IDs is utilized to represent a plurality of combinations of the UGL and the ULRP. As shown by the table diagram 400D, the UGL and the ULRP can be respectively indicated by data bits. A first amount of bits representing a group of UGL and a second amount of bits representing a group of ULRP. The first amount and the second amount may or may not be different. By having different amounts of bits for UGL and ULRP, resource is retained, and the flexibility of bits' assignment is improved.

As shown by the table diagram 400A, in one aspect, ID 0 represents the UGL of 1 ms and the ULRP of 20 ms; ID 1 represents the UGL of 1 ms and the ULRP of 40 ms; ID 2 represents the UGL of 1 ms and the ULRP of 80 ms; ID 3 represents the UGL of 1 ms and the ULRP of 160 ms; ID 4 represents the UGL of 0.125 ms and the ULRP of 2.5 ms; ID 5 represents the UGL of 0.125 ms and the ULRP of 5 ms; ID 6 represents the UGL of 0.125 ms and the ULRP of 10 ms; and ID 7 represents the UGL of 0.125 ms and the ULRP of 20 ms. ID 0 to ID 3 are for clustered UL gap pattern, where the UL gap has a relative long UGL and relative long ULRP (e.g. multiple slots of one UL gap in succession). ID 4 to ID 7 are for distributed UL gap pattern where the UL gap has a relative short UGL and relative short ULRP (e.g. multiple UL gaps within one radio frame).

As shown by the table diagram 400B, in another aspect, ID 0 represents the UGL of 1 ms and the ULRP of 40 ms; ID 1 represents the UGL of 0.125 ms and the ULRP of 5 ms; ID 2 represents the UGL of 0.5 ms and the ULRP of 40 ms or the UGL of 0.125 ms and the ULRP of 10 ms; and ID 3 represents the UGL of 0.125 ms and the ULRP of 20 ms. The UL gap patterns of ID 0 and ID 1 have an overhead of 2.5%, where the overhead is defined as a ratio of UGL/ULRP. The UL gap pattern of ID 1 has an overhead of 1.25%. The UL gap pattern of ID 2 has an overhead of 0.625%.

As shown by the table diagram 400C, in another further aspect, ID 0 represents the UGL of 1 ms and the ULRP of 40 ms with an overhead of 2.5%, and ID 1 represents the UGL of 0.125 ms and the ULRP of 10 ms with an overhead of 1.25%.

As shown by the table diagram 400D, alternatively, 1 bit can be used to indicate the UGL of 1 ms or 0.125 ms, 3 bits can be used to indicate the ULRP of 5 ms, 10 ms, 20 ms, 40 ms, 80 ms, or 160 ms. Though not shown by additional diagrams, different UGL, ULRP options and different bits can be used such as 1 bit for UGL and 2 bits for ULRP, or 1 bit for UGL and 1 bit for ULRP. In one aspect, the amount of bits representing the UGL may be the same amount of bits representing the ULRP. In an alternative aspect, the amount of bits representing the UGL may be a different amount of bits, such as smaller than those representing the ULRP.

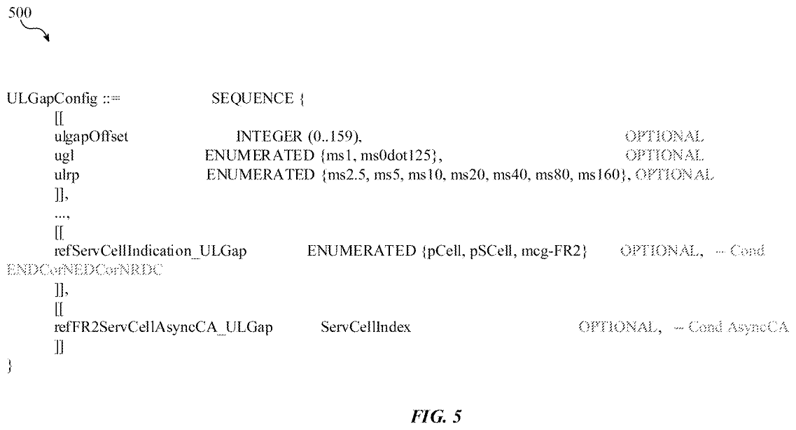

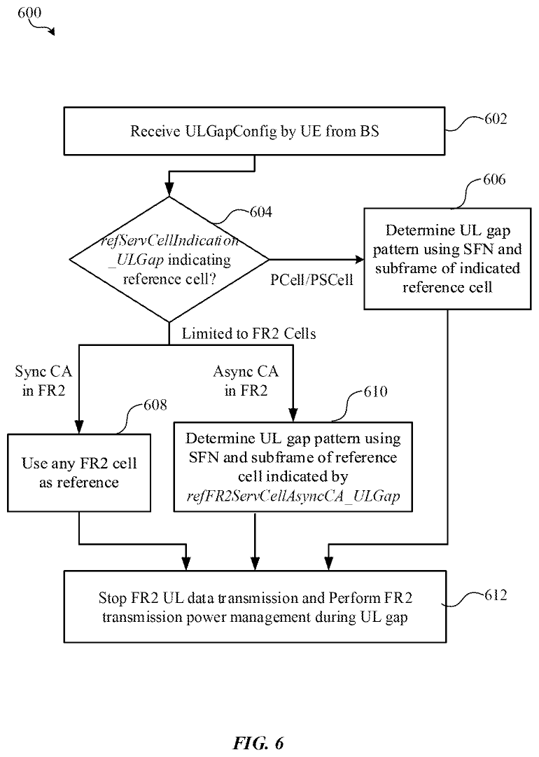

FIG. 5 illustrates a diagram 500 showing an example definition of a UL gap configuration of an RRC message in accordance with some aspects. In one aspect, the UL gap is configured by dedicated radio resource control (RRC) signaling from the BS 111 to the UE 101 (referring to FIG. 1). FIG. 6 illustrates a flow diagram 600 showing a method of configuring the UL gap from the BS 111 to the UE 101 (referring to FIG. 1) using an RRC message in accordance with some aspects.

As shown by FIG. 5 and act 602 of FIG. 6, a field or an information element (IE) ULGapConfig can be received by the UE from the BS and adopted for the UL gap configuration. In a multi-radio dual connectivity (MR-DC) configuration, such as EN-DC, NE-DC or NR-DC, the IE ULGapConfig may indicate a reference cell for determining a UL gap pattern based on timing and numerology of the reference cell. In some aspects, the reference cell can be the PCell or the PSCell in various frequency ranges such as FR1 and FR2. FR1 is referred to a frequency band of 4.1 GHz to 7.125 GHz. FR2 is referred to a frequency band of 24.25 GHz to 52.6 GHz.

As shown by FIG. 5 and act 604 and act 606 of FIG. 6, a reference cell indication parameter refServCellIndication_ULGap is checked and used to configure the reference cell if present. The reference cell indication parameter refServCellIndication_ULGap may indicate a reference cell selection from PCell or PSCell or alternatively indicate that the reference cell should be limited to FR2 cells. For NE-DC and NR-DC, the reference cell is limited to FR2 cells of MCG. A system frame number (SFN) and a subframe of the reference cell may be used for determining the UL gap pattern. This allows potentially a FR1 cell used for timing reference.

As shown by FIG. 5 and act 604 and act 610 of FIG. 6, if the reference cell indication parameter refServCellIndication_ULGap does not indicate a specific reference cell, but indicates that the reference cell is limited to FR2 cells, and in case of asynchronous carrier aggregation (CA) in FR2, in some aspects, a FR2 asynchronous reference cell indication parameter refFR2ServCellAsyncCA_ULGap may indicate a reference cell index, as a reference cell ID indicating the reference cell used for determining the UL gap pattern.

As shown by act 604 and act 608 of FIG. 6, if the reference cell indication parameter refServCellIndication_ULGap does not indicate a specific reference cell, but indicates that the reference cell is limited to FR2 cells, and in case of synchronous CA in FR2, SFN and subframe of any cell in FR2 can be used for determining the UL gap pattern.

In some alternative aspects, the reference cell can be hard coded as limited to FR2 cells for simplicity, and not cells in lower frequency ranges such as FR1. There is no refServCellIndication_ULGap in the UL gap RRC configuration itself. Only refFR2ServCellAsyncCA_ULGap is signaled indicating a reference cell index for the FR2 reference cell used for determining the UL gap pattern. In case of asynchronous CA in FR2, the reference cell may be configured by the FR2 asynchronous reference cell indication parameter refFR2ServCellAsyncCA_ULGap. Alternatively, the PSCell can be used as the reference cell. A system frame number (SFN) and subframe of the reference cell is used for determining a UL gap pattern. In case of synchronous CA in FR2, a reference cell is not configured by the IE ULGapConfig, the SFN and subframe of any cell in FR2 can be used for determining a UL gap pattern.

As shown by FIG. 5, in some aspects, ULGapConfig may include configuration of the ULGapOffset, the UGL, and the ULRP. The ULGapOffset may be in a range of 0 to ULRP−1. The UGL, and the ULRP may be indicated by separate bits, or by the UL gap pattern ID as described above. In some alternative aspects, the UL gap pattern can be derived from static uplink slots of a time division duplex (TDD) uplink/downlink configuration such as TDD UL/DL configuration common message TDD-UL-DL-ConfigurationCommon and TDD ULJDL configuration dedicated message TDD-UL-DL-ConfigurationDedicated with the same reference cell or reference cell index indication of ULGapConfig.

As shown by act 612 of FIG. 6, in some aspects, the UE stops UL data transmission on FR2 cells and perform a FR2 transmission power management during the UL gap. For example, the UE may perform a body proximity sensing using a body proximity sensor to detect presence or absence of human target(s) in close proximity around a radiating FR2 antenna panel. Then, the UE is able to selectively apply additional power management maximum power reduction (P-MPR) or operating duty cycle in compliance of a 5G FR2 cellular radio regulatory only when human targets are at positions in which significant RF exposure by a directional beam can be caused, and thus improve overall system throughput.

In one aspect, the UE is configured to support UL gap capability independent from a measurement gap capability. As such, UE measurements continue through an internal loop when the measurement gap overlaps with the UL gap. The UE measurements may include synchronization signal-reference signal received power (SS-RSRP), synchronization signal-reference signal received quality (SS-RSRQ), synchronization signal-signal to interference and noise ratio (SS-SINR), channel state information-reference signal received power (CSI-RSRP), CSI-RSRQ, CSI-SINR, or other application UE measurement.

In one further aspect, the UE capability report indicates to support per-FR gap, where data transmission and reception of FR1 or another frequency range still continue during the UL gap for FR2. The UE stops uplink data transmission on all FR2 cells during the UL gap. In one further aspect, the UL gap is configured by a network entity supporting or configuring FR2 communication, such that coordination with other network entities and UE appreciation are simplified. For example, for EN-DC, the secondary NR node configures the UL gap.

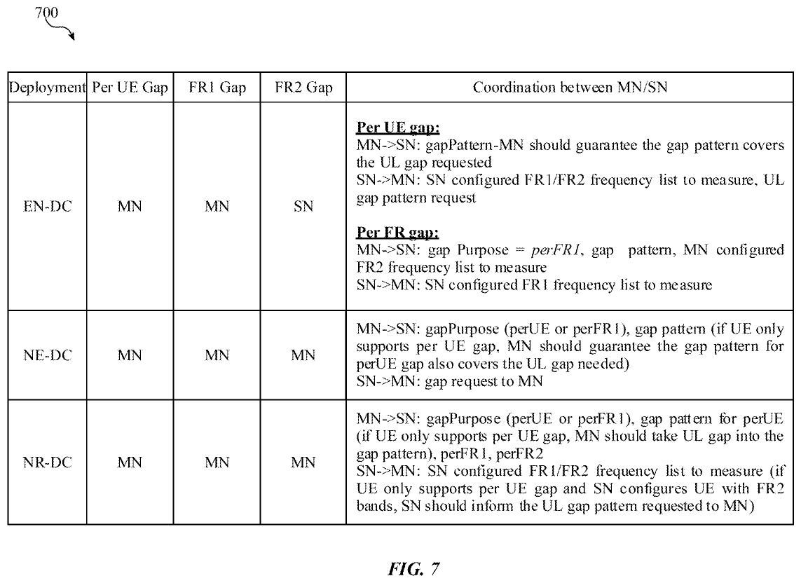

FIG. 7 illustrates a table diagram 700 illustrating master node (MN)-secondary node (SN) coordination for UL gap configuration in accordance with some aspects. In one aspect, the UE capability report indicates per-UE gap, where data transmission and reception of FR1 or another frequency range are also affected during the UL gap for FR2. In this case, the UE is able to share some components between FR2 and FR1 or another frequency range, and UE implementation structures are integrated. However, the MN and the SN need to coordinate at a network side to align the UL gap configuration from the master node with the SN especially if the SN is responsible for a FR2 measurement gap configuration.

As shown in FIG. 7, for the per-UE gap of the EN-DC, the MN is responsible for the UL gap configuration. The SN should send the SN configured FR1/FR2 measurement frequency list and a UL gap pattern request to the MN. The MN should send a gap pattern information to the SN including the UL gap pattern by the per-UE gap configuration.

For NE-DC and NR-DC, the MN is responsible for the UL gap configuration for the per-UE gap and the per-FR gaps. The SN should send SN configured FR1/FR2 measurement frequency list if applicable and a UL gap pattern request to the MN especially if the SN configures the UE with FR2 bands. The MN should guarantee the UL gap pattern is included and sent to the SN if the UE only supports the per-UE gap.

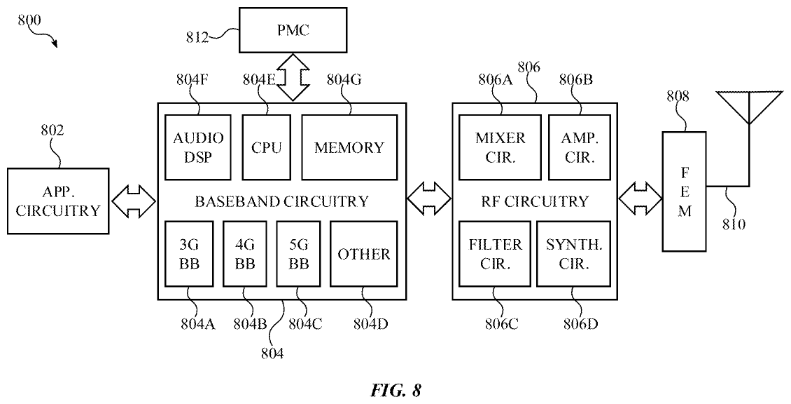

FIG. 8 illustrates a diagram illustrating example components of a device 800 that can be employed in accordance with some aspects. In some implementations, the device 800 can include application circuitry 802, baseband circuitry 804. Radio Frequency (RF) circuitry 806, front-end module (FEM) circuitry 808, one or more antennas 810, and power management circuitry (PMC) 812 coupled together at least as shown. The components of the illustrated device 800 can be included in a UE or a RAN node. In some implementations, the device 800 can include fewer elements (e.g., a RAN node may not utilize application circuitry 802 and instead include a processor/controller to process IP data received from a CN. In some implementations, the device 800 can include additional elements such as, for example, memory/storage, display, camera, sensor (including one or more temperature sensors, such as a single temperature sensor, a plurality of temperature sensors at different locations in device 800, etc.), or input/output (I/O) interface. In other implementations, the components described below can be included in more than one device (e.g., said circuitries can be separately included in more than one device for Cloud-RAN (C-RAN) implementations).

The application circuitry 802 can include one or more application processors. For example, the application circuitry 802 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 800. In some implementations, processors of application circuitry 802 can process IP data packets received from an evolved packet core (EPC).

The baseband circuitry 804 can include circuitry such as, but not limited to, one or more single-core or multi-core processors. The baseband circuitry 804 can include one or more baseband processors or control logic to process baseband signals received from a receive signal path of the RF circuitry 806 and to generate baseband signals for a transmit signal path of the RF circuitry 806. Baseband circuitry 804 can interface with the application circuitry 802 for generation and processing of the baseband signals and for controlling operations of the RF circuitry 806. For example, in some implementations, the baseband circuitry 804 can include a third generation (3G) baseband processor 804A, a fourth generation (4G) baseband processor 804B, a fifth generation (5G) baseband processor 804C, or other baseband processor(s) 804D for other existing generations, generations in development or to be developed in the future (e.g., second generation (2G), sixth generation (6G), etc.). The baseband circuitry 804 (e.g., one or more of baseband processors 804A-D) can handle various radio control functions that enable communication with one or more radio networks via the RF circuitry 806. In other implementations, some or all of the functionality of baseband processors 804A-D can be included in modules stored in the memory 804G and executed via a Central Processing Unit (CPU) 804E. The radio control functions can include but are not limited to signal modulation/demodulation, encoding/decoding, radio frequency shifting, etc. In some implementations, modulation/demodulation circuitry of the baseband circuitry 804 can include Fast-Fourier Transform (FFT), precoding, or constellation mapping/demapping functionality. In some implementations, encoding/decoding circuitry of the baseband circuitry 804 can include convolution, tail-biting convolution, turbo, Viterbi. or Low Density Parity Check (LDPC) encoder/decoder functionality. Implementations of modulation/demodulation and encoder/decoder functionality are not limited to these examples and can include other suitable functionality in other implementations.

In some implementations, the baseband circuitry 804 can include one or more audio digital signal processor(s) (DSP) 804F. The audio DSP(s) 804F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 804 and the application circuitry 802 can be implemented together such as, for example, on a system on a chip (SOC).

In some implementations, the baseband circuitry 804 can provide for communication compatible with one or more radio technologies. For example, in some implementations, the baseband circuitry 804 can support communication with an NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 804 is configured to support radio communications of more than one wireless protocol can be referred to as multi-mode baseband circuitry.

RF circuitry 806 can enable communication with wireless networks using modulated electromagnetic radiation through a non-solid medium. In various implementations, the RF circuitry 806 can include switches, filters, amplifiers, etc., to facilitate communication with the wireless network. RF circuitry 806 can include a receive signal path which can include circuitry to down-convert RF signals received from the FEM circuitry 808 and provide baseband signals to the baseband circuitry 804. RF circuitry 806 can also include a transmit signal path which can include circuitry to up-convert baseband signals provided by the baseband circuitry 804 and provide RF output signals to the FEM circuitry 808 for transmission.

In some implementations, the receive signal path of the RF circuitry 806 can include mixer circuitry 806a, amplifier circuitry 806b, and filter circuitry 806c. In some implementations, the transmit signal path of the RF circuitry 806 can include filter circuitry 806c and mixer circuitry 806a. RF circuitry 806 can also include synthesizer circuitry 806d for synthesizing a frequency for use by the mixer circuitry 806a of the receive signal path and the transmit signal path. In some implementations, the mixer circuitry 806a of the receive signal path can be configured to down-convert RF signals received from the FEM circuitry 808 based on the synthesized frequency provided by synthesizer circuitry 806d. The amplifier circuitry 806b can be configured to amplify the down-converted signals, and the filter circuitry 806c can be a low-pass filter (LPF) or fband-pass filter (BPF) configured to remove unwanted signals from the down-converted signals to generate output baseband signals. Output baseband signals can be provided to the baseband circuitry 804 for further processing. In some implementations, the output baseband signals can be zero-frequency baseband signals, although this is not a requirement. In some implementations, mixer circuitry 806a of the receive signal path can comprise passive mixers, although the scope of the implementations is not limited in this respect.

In some implementations, the mixer circuitry 806a of the transmit signal path can be configured to up-convert input baseband signals based on the synthesized frequency provided by the synthesizer circuitry 806d to generate RF output signals for the FEM circuitry 808. The baseband signals can be provided by the baseband circuitry 804 and can be filtered by filter circuitry 806c.

In some implementations, the mixer circuitry 806a of the receive signal path and the mixer circuitry 806a of the transmit signal path can include two or more mixers and can be arranged for quadrature downconversion and upconversion, respectively. In some implementations, the mixer circuitry 806a of the receive signal path and the mixer circuitry 806a of the transmit signal path can include two or more mixers and can be arranged for image rejection (e.g., Hartley image rejection). In some implementations, the mixer circuitry 806a of the receive signal path and the mixer circuitry 806a can be arranged for direct downconversion and direct upconversion, respectively. In some implementations, the mixer circuitry 806a of the receive signal path and the mixer circuitry 806a of the transmit signal path can be configured for super-heterodyne operation.

In some implementations, the output baseband signals and the input baseband signals can be analog baseband signals, although the scope of the implementations is not limited in this respect. In some alternate implementations, the output baseband signals and the input baseband signals can be digital baseband signals. In these alternate implementations, the RF circuitry 806 can include analog-to-digital converter (ADC) and digital-to-analog converter (DAC) circuitry, and the baseband circuitry 804 can include a digital baseband interface to communicate with the RF circuitry 806.

In some dual-mode implementations, a separate radio IC circuitry can be provided for processing signals for each spectrum, although the scope of the implementations is not limited in this respect.

In some implementations, the synthesizer circuitry 806d can be a fractional-N synthesizer or a fractional N/N+1 synthesizer, although the scope of the implementations is not limited in this respect as other types of frequency synthesizers can be suitable. For example, synthesizer circuitry 806d can be a delta-sigma synthesizer, a frequency multiplier, or a synthesizer comprising a phase-locked loop with a frequency divider.

The synthesizer circuitry 806d can be configured to synthesize an output frequency for use by the mixer circuitry 806a of the RF circuitry 806 based on a frequency input and a divider control input. In some implementations, the synthesizer circuitry 806d can be a fractional N/N+1 synthesizer.

In some implementations, frequency input can be provided by a voltage-controlled oscillator (VCO), although that is not a requirement. Divider control input can be provided by either the baseband circuitry 804 or the application circuitry 802, depending on the desired output frequency. In some implementations, a divider control input (e.g., N) can be determined from a look-up table based on a channel indicated by the application circuitry 802.

Synthesizer circuitry 806d of the RF circuitry 806 can include a divider, a delay-locked loop (DLL), a multiplexer, and a phase accumulator. In some implementations, the divider can be a dual modulus divider (DMD), and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump, and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 806d can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 806 can include an IQ/polar converter.

FEM circuitry 808 can include a receive signal path which can include circuitry configured to operate on RF signals received from one or more antennas 56, amplify the received signals and provide the amplified versions of the received signals to the RF circuitry 806 for further processing. FEM circuitry 808 can also include a transmit signal path which can include circuitry configured to amplify signals for transmission provided by the RF circuitry 806 for transmission by one or more of the one or more antennas 56. In various implementations, the amplification through the transmit or receive signal paths can be done solely in the RF circuitry 806, solely in the FEM circuitry 808, or in both the RF circuitry 806 and the FEM circuitry 808.

In some implementations, the FEM circuitry 808 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 806). The transmit signal path of the FEM circuitry 808 can include a power amplifier (PA) to amplify input RF signals (e.g., provided by RF circuitry 806), and one or more filters to generate RF signals for subsequent transmission (e.g., by one or more of the one or more antennas 56).

In some implementations, the PMC 812 can manage power provided to the baseband circuitry 804. In particular, the PMC 812 can control power-source selection, voltage scaling, battery charging, or DC-to-DC conversion. The PMC 812 can often be included when the device 800 is capable of being powered by a battery, for example, when the device is included in a UE. The PMC 812 can increase the power conversion efficiency while providing desirable implementation size and heat dissipation characteristics.

While FIG. 8 shows the PMC 812 coupled only with the baseband circuitry 804. However, in other implementations, the PMC 812 may be additionally or alternatively coupled with, and perform similar power management operations for, other components such as, but not limited to, application circuitry 802, RF circuitry 806, or FEM circuitry 808.

In some implementations, the PMC 812 can control, or otherwise be part of, various power saving mechanisms of the device 800. For example, if the device 800 is in an RRC_Connected state, where it is still connected to the RAN node as it expects to receive traffic shortly, then it can enter a state known as Discontinuous Reception Mode (DRX) after a period of inactivity. During this state, the device 800 can power down for brief intervals of time and thus save power.

If there is no data traffic activity for an extended period of time, then the device 800 can transition off to an RRC_Idle state, where it disconnects from the network and does not perform operations such as channel quality feedback, handover, etc. The device 800 goes into a very low power state and it performs paging where again it periodically wakes up to listen to the network and then powers down again. The device 800 may not receive data in this state; in order to receive data, it can transition back to RRC_Connected state.

An additional power saving mode can allow a device to be unavailable to the network for periods longer than a paging interval (ranging from seconds to a few hours). During this time, the device is totally unreachable to the network and can power down completely. Any data sent during this time incurs a large delay and it is assumed the delay is acceptable.

Processors of the application circuitry 802 and processors of the baseband circuitry 804 can be used to execute elements of one or more instances of a protocol stack. For example, processors of the baseband circuitry 804, alone or in combination, can be used execute Layer 3, Layer 2, or Layer 1 functionality, while processors of the baseband circuitry 804 can utilize data (e.g., packet data) received from these layers and further execute Layer 4 functionality (e.g., transmission communication protocol (TCP) and user datagram protocol (UDP) layers). As referred to herein, Layer 3 can comprise a radio resource control (RRC) layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

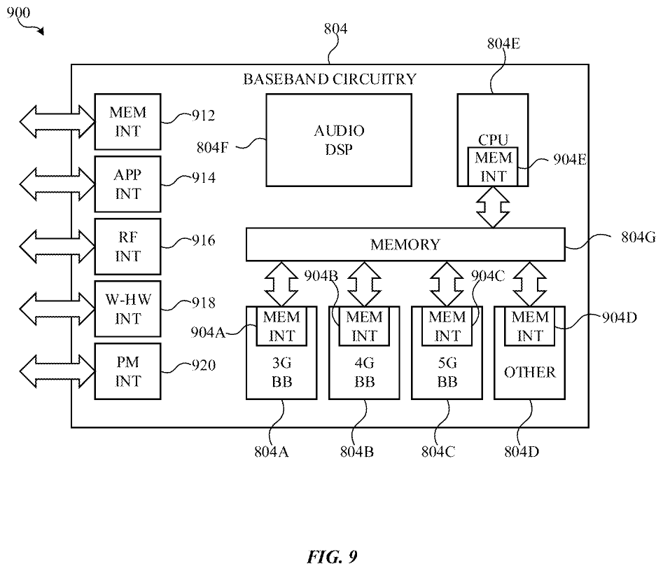

FIG. 9 illustrates a diagram illustrating example interfaces of baseband circuitry that can be employed in accordance with some aspects. As discussed above, the baseband circuitry 804 of FIG. 8 can comprise processors 804A-804E and a memory 804G utilized by said processors. Each of the processors 804A-804E can include a memory interface. 904A-904E, respectively, to send/receive data to/from the memory 8040.

The baseband circuitry 804 can further include one or more interfaces to communicatively couple to other circuitries/devices, such as a memory interface 912 (e.g., an interface to send/receive data to/from memory external to the baseband circuitry 804), an application circuitry interface 914 (e.g., an interface to send/receive data to/from the application circuitry 802 of FIG. 8), an RF circuitry interface 916 (e.g., an interface to send/receive data to/from RF circuitry 806 of FIG. 8), a wireless hardware connectivity interface 918, and a power management interface 720 (e.g., an interface to send/receive power or control signals to/from the PMC 812).

While the methods described within this disclosure are illustrated in and described herein as a series of acts or events, it will be appreciated that the illustrated ordering of such acts or events are not to be interpreted in a limiting sense. For example, some acts can occur in different orders and/or concurrently with other acts or events apart from those illustrated and/or described herein. In addition, not all illustrated acts can be required to implement one or more aspects or aspects of the description herein. Further, one or more of the acts depicted herein can be carried out in one or more separate acts and/or phases. Reference can be made to the figures described above for ease of description. However, the methods are not limited to any particular aspect, aspect or example provided within this disclosure and can be applied to any of the systems/devices/components disclosed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

As it is employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor can also be implemented as a combination of computing processing units.

While the disclosure has been illustrated, and described with respect to one or more implementations, alterations and/or modifications may be made to the illustrated examples without departing from the spirit and scope of the appended claims. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the disclosure.

The above description of illustrated aspects of the subject disclosure, including what is described in the Abstract, is not intended to be exhaustive or to limit the disclosed aspects to the precise forms disclosed. While specific aspects and examples are described herein for illustrative purposes, various modifications are possible that are considered within the scope of such aspects and examples, as those skilled in the relevant art can recognize.

### ADDITIONAL EXAMPLES

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to aspects and examples described.

Example 1 is an apparatus of a user equipment (UE), the UE comprising a baseband processor configured to perform operations comprising receiving an uplink (UL) gap configuration for a UL gap by dedicated radio resource control (RRC) signaling from a base station (BS), the UL gap configuration indicating a reference cell for a multi-radio dual connectivity (MR-DC) configuration; determining a UL gap pattern based on the received UL gap configuration; and stopping UL data transmission on Frequency Range 2 (FR2) cells and performing a FR2 transmission power management during the UL gap.

Example 2 comprises the subject matter of any variation of any of example(s) 1, wherein the performance of the FR2 transmission power management during the UL gap comprising performing a body proximity sensing using a body proximity sensor to detect presence or absence of human target(s) in close proximity around a radiating FR2 antenna panel; and selectively applying additional power management maximum power reduction (P-MPR) or operating duty cycle based on a result of the performed the body proximity sensing.

Example 3 comprises the subject matter of any variation of any of example(s) 1-2, wherein the UL gap configuration indicates a system frame number (SFN) and a subframe of the reference cell used for calculating the UL gap pattern.

Example 4 comprises the subject matter of any variation of any of example(s) 1-3, wherein the reference cell is a FR2 cell.

Example 5 comprises the subject matter of any variation of any of example(s) 1-3, wherein the reference cell is configured by a reference cell indication parameter selected from a list of cells including a FR1 cell.

Example 6 comprises the subject matter of any variation of any of example(s) 5, wherein the reference cell is configured by a FR2 asynchronous reference cell indication parameter indicating a FR2 cell if the reference cell is not configured by the reference cell indication parameter and in case of asynchronous carrier aggregation (CA) in FR2.

Example 7 comprises the subject matter of any variation of any of example(s) 1-3, wherein the reference cell is configured by a FR2 asynchronous reference cell indication parameter indicating a FR2 cell in case of asynchronous carrier aggregation (CA) in FR2.

Example 8 comprises the subject matter of any variation of any of example(s) 1-3, wherein the UE is configured to continue Frequency Range 1 (FR1) communication during the UL gap.

Example 9 comprises the subject matter of any variation of any of example(s) 1-3, wherein the UE is configured to continue UE measurements indicated by a measurement gap during the UL gap.

Example 10 comprises the subject matter of any variation of any of example(s) 1-3, wherein the UE is configured to stop Frequency Range 1 (FR1) communication during the UL gap.

Example 11 comprises the subject matter of any variation of any of example(s) 1-3, wherein the baseband processor is configured to derive the UL gap pattern based on a time division duplex (TDD) uplink/downlink configuration with the same reference cell indication.

Example 12 comprises the subject matter of any variation of any of example(s) 1-3, wherein the UL gap configuration comprises a plurality of UL gap pattern IDs corresponding to a plurality combinations of a UL gap length and a UL gap repetition period.

Example 13 comprises the subject matter of any variation of any of example(s) 1-3, wherein the UL gap configuration comprises a first amount of bits representing a group of UL gap lengths and a second amount of bits representing a group of UL gap repetition periods, wherein the first amount is different than the second amount.

Example 14 comprises the subject matter of any variation of any of example(s) 1-3, wherein the UL gap configuration comprises 1 bit representing a UL gap length of 1 ms or 0.125 ms and 3 bits representing a UL gap repetition period of 5 ms, 10 ms, 20 ms, 40 ms, 80 ms, or 160 ms.

Example 15 is an apparatus of a base station (BS), the BS comprising a baseband processor configured to perform operations comprising transmitting an uplink (UL) gap configuration for a UL gap by dedicated radio resource control (RRC) signaling to a user equipment (UE), the UL gap configuration indicating a reference cell for a multi-radio dual connectivity (MR-DC) configuration for determining a UL gap pattern for the UL gap and stopping communications with the UE for the UE to perform a Frequency Range 2 (FR2) transmission power management during the UL gap.

Example 16 comprises the subject matter of any variation of any of example(s) 15, wherein the BS is configured to receive a UL gap pattern request from a secondary BS and send the UL gap pattern to the secondary BS if the UE supports a per-UE gap and the secondary BS configures the UE for EN-DC.

Example 17 comprises the subject matter of any variation of any of example(s) 15, wherein the BS is configured to send the UL gap pattern to a secondary BS if the UE supports a per-UE gap for NE-DC.

Example 18 comprises the subject matter of any variation of any of example(s) 15, wherein the BS is configured to receive a UL gap pattern request from a secondary BS and send the UL gap pattern to the secondary BS if the UE supports a per-UE gap and the secondary BS configures the UE with FR2 bands for NR-DC.

Example 19 is a method of configuring an uplink (UL) gap, comprising receiving an uplink (UL) gap configuration for the UL gap by dedicated radio resource control (RRC) signaling by a user equipment (UE) from a base station (BS), the UL gap configuration indicating a reference cell for a multi-radio dual connectivity (MR-DC) configuration; determining a UL gap pattern based on the received UL gap configuration; and stopping UL data transmission on Frequency Range 2 (FR2) cells and performing a FR2 transmission power management during the UL gap.

Example 20 comprises the subject matter of any variation of any of example(s) 19, performing the FR2 transmission power management comprising: performing a body proximity sensing using a body proximity sensor to detect presence or absence of human target(s) in close proximity around a radiating FR2 antenna panel; and selectively applying additional power management maximum power reduction (P-MPR) or operating duty cycle based on a result of the performed the body proximity sensing.

Example 21 is a method that includes any action or combination of actions as substantially described herein in the Detailed Description.

Example 22 is a method as substantially described herein with reference to each or any combination of the Figures included herein or with reference to each or any combination of paragraphs in the Detailed Description.

Example 23 is a user equipment configured to perform any action or combination of actions as substantially described herein in the Detailed Description as included in the user equipment.

Example 24 is a network node configured to perform any action or combination of actions as substantially described herein in the Detailed Description as included in the network node.

Example 25 is a non-volatile computer-readable medium that stores instructions that, when executed, cause the performance of any action or combination of actions as substantially described herein in the Detailed Description.

Example 26 is a baseband processor of a user equipment configured to perform any action or combination of actions as substantially described herein in the Detailed Description as included in the user equipment.

Example 27 is a baseband processor of a network node configured to perform any action or combination of actions as substantially described herein in the Detailed Description as included in the user equipment.

Example 28 includes a product comprising one or more tangible computer-readable non-transitory storage media comprising computer-executable instructions operable to, when executed by at least one computer processor, enable the at least one processor to perform the method of any one of the Examples above.

1. An apparatus of a user equipment (UE), the UE comprising a baseband processor configured to perform operations comprising:
receiving an uplink (UL) gap configuration for a UL gap by dedicated radio resource control (RRC) signaling from a base station (BS), the UL gap configuration indicating a reference cell for a multi-radio dual connectivity (MR-DC) configuration;
determining a UL gap pattern based on the received UL gap configuration; and
stopping UL data transmission on Frequency Range 2 (FR2) cells and performing a FR2 transmission power management during the UL gap.

2. The apparatus of claim 1, wherein the performance of the FR2 transmission power management during the UL gap comprising:
performing a body proximity sensing using a body proximity sensor to detect presence or absence of human target(s) in close proximity around a radiating FR2 antenna panel; and
selectively applying additional power management maximum power reduction (P-MPR) or operating duty cycle based on a result of the performed the body proximity sensing.

3. The apparatus of claim 1, wherein the UL gap configuration indicates a system frame number (SFN) and a subframe of the reference cell used for calculating the UL gap pattern.

4. The apparatus of claim 1, wherein the reference cell is a FR2 cell.

5. The apparatus of claim 1, wherein the reference cell is configured by a reference cell indication parameter selected from a list of cells including a FR1 cell.

6. The apparatus of claim 5, wherein the reference cell is configured by a FR2 asynchronous reference cell indication parameter indicating a FR2 cell if the reference cell is not configured by the reference cell indication parameter and in case of asynchronous carrier aggregation (CA) in FR2.

7. The apparatus of claim 1, wherein the reference cell is configured by a FR2 asynchronous reference cell indication parameter indicating a FR2 cell in case of asynchronous carrier aggregation (CA) in FR2.

8. The apparatus of claim 1, wherein the UE is configured to continue Frequency Range 1 (FR1) communication during the UL gap.

9. The apparatus of claim 1, wherein the UE is configured to continue UE measurements indicated by a measurement gap during the UL gap.

10. The apparatus of claim 1, wherein the UE is configured to stop Frequency Range 1 (FR1) communication during the UL gap.

11. The apparatus of claim 1, wherein the baseband processor is configured to derive the UL gap pattern based on a time division duplex (TDD) uplink/downlink configuration with the same reference cell indication.

12. The apparatus of claim 1, wherein the UL gap configuration comprises a plurality of UL gap pattern Is corresponding to a plurality combinations of a UL gap length and a UL gap repetition period.

13. The apparatus of claim 1, wherein the UL gap configuration comprises a first amount of bits representing a group of UL gap lengths and a second amount of bits representing a group of UL gap repetition periods, wherein the first amount is different than the second amount.

14. The apparatus of claim 1, wherein the UL gap configuration comprises 1 bit representing a UL gap length of 1 ms or 0.125 ms and 3 bits representing a UL gap repetition period of 5 ms, 10 ms, 20 ms, 40 ms, 80 ms, or 160 ms.

15. An apparatus of a base station (BS), the BS comprising a baseband processor configured to perform operations comprising:
transmitting an uplink (UL) gap configuration for a UL gap by dedicated radio resource control (RRC) signaling to a user equipment (UE), the UL gap configuration indicating a reference cell for a multi-radio dual connectivity (MR-DC) configuration for determining a UL gap pattern for the UL gap; and
stopping communications with the UE for the UE to perform a Frequency Range 2 (FR2) transmission power management during the UL gap.

16. The apparatus of claim 15, wherein the BS is configured to receive a UL gap pattern request from a secondary BS and send the UL gap pattern to the secondary BS if the UE supports a per-UE gap and the secondary BS configures the UE for EN-DC.

17. The apparatus of claim 15, wherein the BS is configured to send the UL gap pattern to a secondary BS if the UE supports a per-UE gap for NE-DC.

18. The apparatus of claim 15, wherein the BS is configured to receive a UL gap pattern request from a secondary BS and send the UL gap pattern to the secondary BS if the UE supports a per-UE gap and the secondary BS configures the UE with FR2 bands for NR-DC.

19. A method of configuring an uplink (UL) gap, comprising:
receiving an uplink (UL) gap configuration for the UL gap by dedicated radio resource control (RRC) signaling by a user equipment (UE) from a base station (BS), the UL gap configuration indicating a reference cell for a multi-radio dual connectivity (MR-DC) configuration;
determining a UL gap pattern based on the received UL gap configuration; and
stopping UL data transmission on Frequency Range 2 (FR2) cells and performing a FR2 transmission power management during the UL gap.

20. The method of claim 19, performing the FR2 transmission power management comprising:
performing a body proximity sensing using a body proximity sensor to detect presence or absence of human target(s) in close proximity around a radiating FR2 antenna panel; and
selectively applying additional power management maximum power reduction (P-MPR) or operating duty cycle based on a result of the performed the body proximity sensing.

21-27. (canceled)
